(19) United States
(12) Patent Application Publication
(10) Pub. No.: US 2026/0093164 A1
(43) Pub. Date: Apr. 2, 2026

(54) CAMERA ATTACHMENT MEMBER

(71) Applicant: i-PRO Co., Ltd., Tokyo (JP)

(72) Inventor: Kento MAEKAWA, Tokyo (JP)

(73) Assignee: i-PRO Co., Ltd., Tokyo (JP)

(21) Appl. No.: 19/112,463

(22) PCT Filed: Sep. 22, 2023
(86) PCT No.: PCT/JP2023/034607

§ 371 Date: Nov. 19, 2025

(30) Foreign Application Priority Data
Oct. 24, 2022 (JP) 2022-169944

(51) Int. Cl. G03B 17/56

(52) U.S. Cl. CPC G03B 17/561

(57) ABSTRACT

A camera attachment member is capable of attaching a camera to a support pipe portion fixed to a support member for supporting the camera at an attachment position. The camera attachment member includes a fastening member with one end portion thereof fixed to the support pipe portion, the fastening member including a flange portion formed at another end portion opposite to the one end portion, and a male thread portion having a diameter smaller than that of the flange portion; a camera attachment surface component having a through hole allowing the one end portion of the fastening member to be inserted therethrough; and a nut capable of being screwed with the male thread portion of the fastening member. The camera attachment surface component placed on the flange portion and rotatable along a rotation direction of the male thread portion is sandwiched between the flange portion and the nut.

### TECHNICAL FIELD

The present disclosure relates to a camera attachment member.

### BACKGROUND ART

In the related art, in order to attach (install) a camera such as a surveillance camera, a support portion fixedly installed at an attachment position (a ceiling, a wall, a pole, or the like), a mount bracket connected to the support portion for hanging the camera, and an attachment member which is an integrated component integrally formed with the mount bracket and to which the camera can be attached may be used (see Non Patent Literature 1). Such an attachment member is formed with a tapered pipe thread to be fastened to a parallel pipe thread formed in the mount bracket, and is configured as a component integrated with the mount bracket by fastening the tapered pipe thread completely onto the parallel pipe thread. After the mount bracket is attached to the support portion, the camera is attached to the attachment member that is a component integrated with the mount bracket, thus being attached (installed) to the attachment position.

### CITATION LIST

### Non-Patent Literature

Non Patent Literature 1: i-PRO Co., Ltd.: “Ceiling mount bracket WV-QSR504-W”, [searched on Oct. 3, 2022] Internet <https://cwc.ipro.com./products/wv-qsr-504-w>

### SUMMARY OF INVENTION

### Technical Problem

However, since the related-art camera is attached to the mount bracket and the attachment member which are integrated by completely fastening the tapered pipe thread and the parallel pipe thread, there is a possibility that the camera cannot be attached in a camera attachment direction (a Pan rotation direction of the camera) desired by a user depending on a fastening position of the threads. Further, although a camera attachment member in which the attachment member and the mount bracket are formed as separate parts has been proposed, since the attachment member is provided with a rib for rotation prevention, there is a possibility that the camera cannot be attached in a camera attachment direction (the Pan rotation direction of the camera) desired by the user.

The present disclosure has been made in view of the above-described circumstances in the related art, and an object thereof is to provide a camera attachment member allowing an attachment direction of a camera to be adjusted easily.

### Solution to Problem

The present disclosure provides a camera attachment member capable of attaching a camera to a support pipe portion fixed to a support that supports the camera at an attachment position, the camera attachment member including: a fastening member with one end portion thereof fixed to the support pipe portion, the fastening member including a flange portion formed at the other end portion opposite to the one end portion, and a male thread portion having a diameter smaller than that of the flange portion; a camera attachment surface component having a through hole allowing the one end portion of the fastening member to be inserted therethrough; and a nut capable of being screwed with the male thread portion of the fastening member, in which the camera attachment surface component placed on the flange portion and rotatable along a rotation direction of the male thread portion is sandwiched between the flange portion and the nut.

### Advantageous Effects of Invention

According to the present disclosure, the attachment direction of the camera can be easily adjusted.

### BRIEF DESCRIPTION OF DRAWINGS

FIG. 1 is an external perspective view of a surveillance camera according to Embodiment 1.

FIG. 2 is a top perspective view of an attachment member.

FIG. 3 is a bottom perspective view of the attachment member.

FIG. 4 is an enlarged perspective view of a main part of a flange portion.

FIG. 5 is a cross-sectional view of the attachment member shown in FIG. 4, which is taken along a line C-C.

FIG. 6 is a cross-sectional view taken along a line D-D in FIG. 4.

FIG. 7 is an enlarged view of a main part shown in FIG. 6.

### DESCRIPTION OF EMBODIMENTS

Hereinafter, embodiments in which a camera attachment member according to the present disclosure is specifically disclosed will be described in detail with reference to the drawings as appropriate. However, unnecessarily detailed description may be omitted. For example, the detailed description of already well-known matters and the redundant description of substantially the same configuration may be omitted. This is to avoid unnecessary redundancy of the following description and facilitate understanding of a person skilled in the art. The accompanying drawings and the following description are provided for a person skilled in the art to sufficiently understand the present disclosure, and are not intended to limit the subject matter described in the claims.

In the following description, a Z axis shown in each drawing indicates an upper-lower direction.

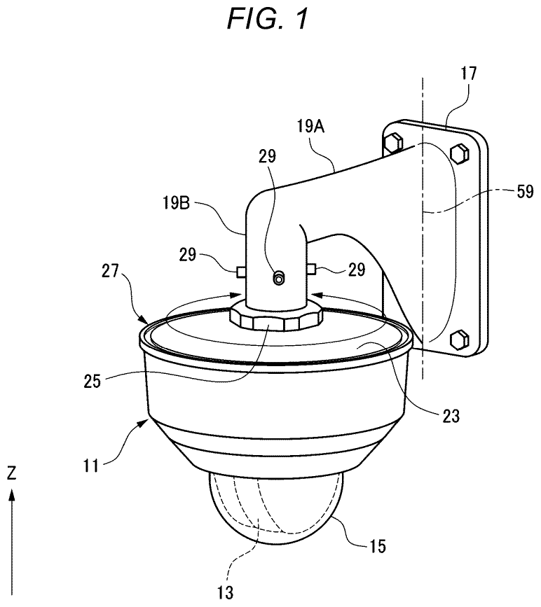

FIG. 1 is an external perspective view of a surveillance camera 11 according to Embodiment 1. In Embodiment 1, the surveillance camera 11 will be described as an example of a camera, but the camera is not limited thereto. For example, the camera may be a camera installed on any attachment target such as a wall, a ceiling, a pillar, a beam, or a pole.

Further, the surveillance camera 11 shown in FIG. 1 may be a monocular camera or a compound eye camera. Further, an external shape of the surveillance camera 11 and an arrangement of a camera unit 13 (imaging part) shown in FIG. 1 are examples, and the present disclosure is not limited thereto. For example, the surveillance camera 11 may be a binocular camera in which two camera units (imaging parts) are arranged in a predetermined direction.

The camera unit 13 referred to herein is an imaging unit for implementing imaging of an imaging area, and may include a solid-state imaging device such as a charged-coupled device (CCD) or a complementary metal oxide semiconductor (CMOS), and may further include a zoom function, and a pan rotation function.

The surveillance camera 11 according to Embodiment 1 images the imaging area that is a surveillance target by the camera unit 13 covered with a dome cover 15 having a dome shape. A support portion 17 (an example of a support) is fixed to a wall to which the surveillance camera 11 is to be attached. The surveillance camera 11 is attached to a predetermined attachment position by being connected, via an attachment member 27, to a support pipe portion 19B of a mount bracket 19A connected to the support portion 17.

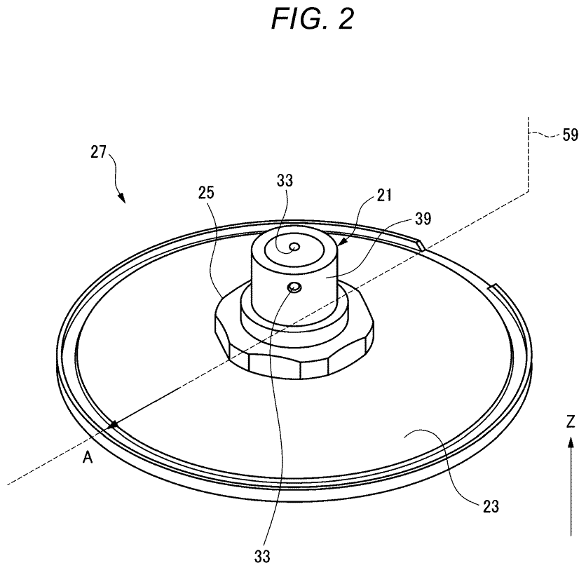

FIG. 2 is a top perspective view of the attachment member 27.

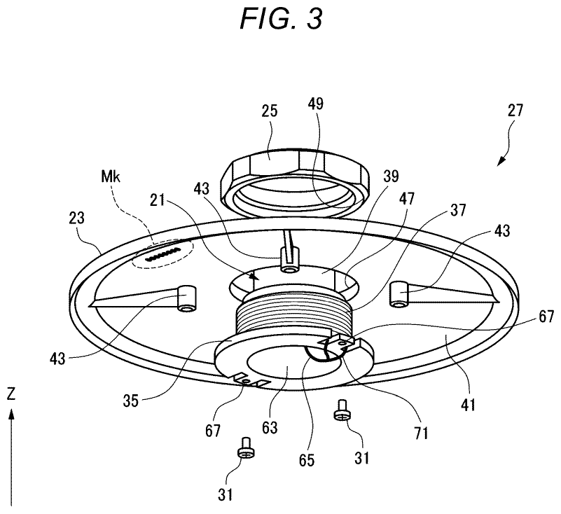

The attachment member 27 includes fixing screws 29 (see FIG. 1), a fastening member 21, a camera attachment surface component 23, a nut 25, and fixing screws 31 (see FIG. 3).

The fastening member 21 is formed in a tubular shape, and one end portion (upper end portion) thereof is inserted into the cylindrical support pipe portion 19B hanging from the mount bracket 19A. In an outer periphery of the support pipe portion 19B, a plurality of (for example, four) holes (not shown) for the fixing screws 29 to be inserted therethrough are formed at substantially equal intervals in a circumferential direction.

On the other hand, the fastening member 21 has a connecting tube portion 39 formed in a cylindrical shape. In the connecting tube portion 39, a plurality of fixing screw holes 33 (see FIG. 2) into which the fixing screws 29 (see FIG. 1) are screwed are provided at positions corresponding to the plurality of holes provided in the support pipe portion 19B, at substantially equal intervals in the circumferential direction.

The fastening member 21 inserted into the support pipe portion 19B is fixed in the support pipe portion 19B by tightening the fixing screws 29 penetrating from the outer periphery of the support pipe portion 19B into the fixing screw holes 33.

FIG. 3 is a bottom perspective view of the attachment member 27.

In the fastening member 21, a flange portion 35 and a male thread portion 37 having a diameter smaller than a diameter of the flange portion 35 are formed in order from the other end portion (lower end portion) toward the upper end portion. The connecting tube portion 39 is connected to an upper end side of the male thread portion 37.

The camera attachment surface component 23 in Embodiment 1 is formed in a substantially disk shape as an example. The camera attachment surface component 23 may be formed in a shape corresponding to the surveillance camera 11 to be attached, and may have, for example, an elliptical plate shape, an oval plate shape, or the like.

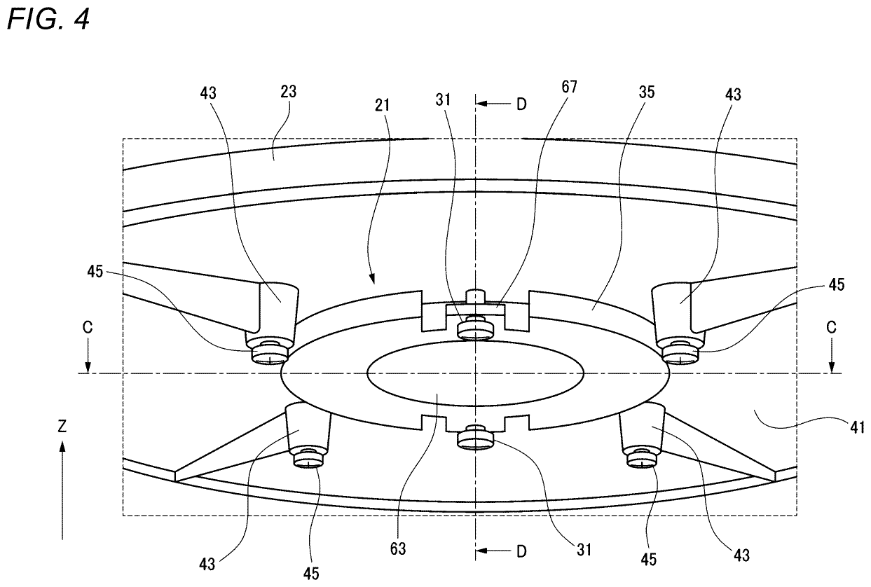

The surveillance camera 11 is attached to an attachment surface 41 of the camera attachment surface component 23 via an attachment metal fitting (not shown). Fixing columns 43 for fixing the attachment metal fitting protrude from the attachment surface 41, and attachment fixing screws 45 (see FIG. 4) are screwed into the attachment surface 41 while penetrating the attachment metal fitting.

In a central portion of the camera attachment surface component 23, a substantially circular through hole 47 is formed substantially concentric with the fastening member 21. In the camera attachment surface component 23, the upper end portion (that is, the connecting tube portion 39) of the fastening member 21 is inserted through the through hole 47 from an attachment surface 41 side to which the surveillance camera 11 is attached. In the camera attachment surface component 23, the fastening member 21 is inserted through the through hole 47 from the attachment surface 41 side, and thus a peripheral edge portion of the through hole 47 is placed on the flange portion 35 of the fastening member 21.

In the camera attachment surface component 23, when the peripheral edge portion of the through hole 47 is placed on the flange portion 35 of the fastening member 21, the connecting tube portion 39 and the male thread portion 37 protrude from a surface (upper surface) opposite to the attachment surface 41 (see FIG. 2).

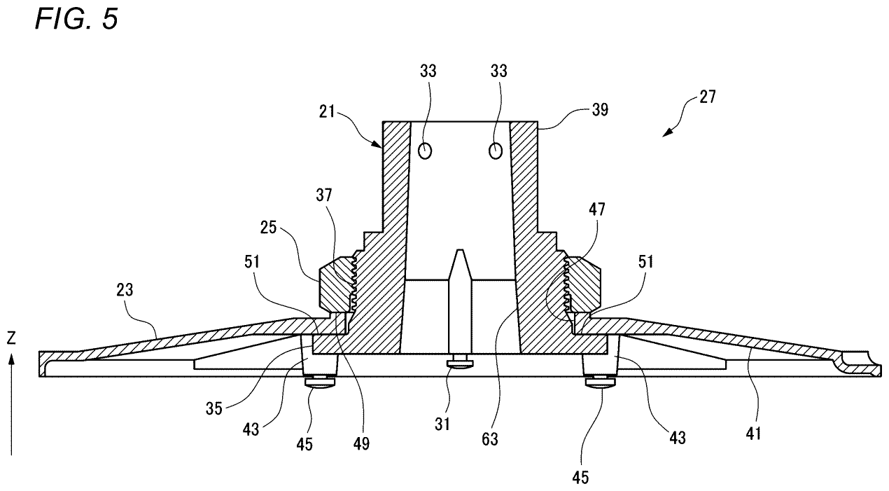

The male thread portion 37 protruding from the through hole 47 is screwed into the nut 25. The camera attachment surface component 23 is fastened to the fastening member 21 in a state where the peripheral edge portion of the through hole 47 of the camera attachment surface component 23 is sandwiched between the flange portion 35 and a contact surface 49 (lower surface) of the nut 25 while being placed on the flange portion 35. That is, the peripheral edge portion of the through hole 47 is sandwiched between the contact surface 49 of the nut 25 and a pressed surface 51 (see FIG. 5) which is a placement surface of the flange portion 35. Accordingly, the fastening member 21 and the camera attachment surface component 23 are integrally fixed.

As shown in FIG. 3, the camera attachment surface component 23 has a mark Mk (an example of a mark) that determines a front position (imaging direction) of the surveillance camera 11. By providing the mark Mk on an inner side of the camera attachment surface component 23 (that is, the attachment surface 41 side), the fixing screws 31 can be screwed while checking the position of the camera attachment surface component 23 to be fixed in to-be-described fixing work of the camera attachment surface component 23 using the fixing screws 31.

In the surveillance camera 11, before the nut 25 is tightened, that is, in a state where the peripheral edge portion of the through hole 47 of the camera attachment surface component 23 is sandwiched between the flange portion 35 and the contact surface 49 (lower surface) of the nut 25, the camera attachment surface component 23 is sandwiched rotatably in a Pan direction with respect to the attachment member 27. Here, the Pan direction referred to herein is a rotation direction with the Z axis as a rotation axis.

In the surveillance camera 11, the camera attachment surface component 23 is rotated in the Pan direction by a worker who performs the attachment work, and can be adjusted to an attachment direction desired by a user. In the surveillance camera 11, after being adjusted to the attachment direction desired by the user, the camera attachment surface component 23 is sandwiched and fixed in a Pan-direction non-rotatable manner by tightening the nut 25.

For example, in a case where the surveillance camera 11 captures images in both directions of a center line 59 of the mount bracket 19A shown in FIG. 1 by the camera unit 13, an imaging direction (attachment direction) of the camera unit 13 attached to the camera attachment surface component 23 can be adjusted to an imaging direction A by tightening the nut 25 after the mark Mk on the attachment surface 41 of the camera attachment surface component 23 is adjusted to be aligned with the imaging direction A.

FIG. 4 is an enlarged perspective view of a main part of the flange portion 35. The fastening member 21 shown in FIG. 4 is fixed to the support pipe portion 19B with the camera attachment surface component 23 sandwiched between the nut 25 and the flange portion 35.

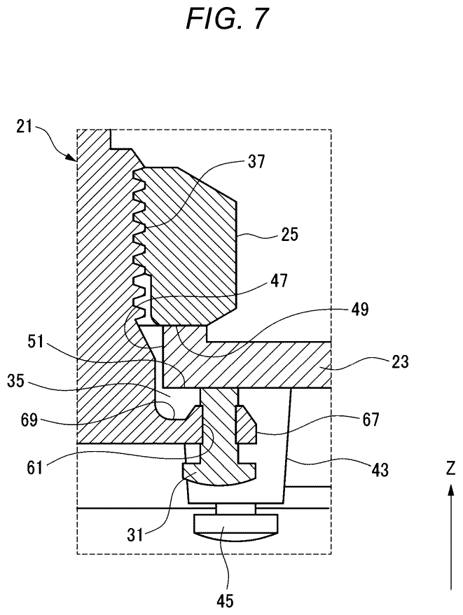

Female thread portions 61 (see FIG. 7) penetrating in a Z direction are formed in the flange portion 35. Tip ends of the fixing screws 31 screwed to the female thread portions 61 of the flange portion 35 from a side opposite to the camera attachment surface component 23 are abutted against the camera attachment surface component 23 sandwiched between the nut 25 and the flange portion 35. A plurality of (for example, two) female thread portions 61 are provided at substantially equal intervals along a circumferential direction of the flange portion 35.

The fixing screw 31 has an under-head length longer than a thickness of the flange portion 35. Accordingly, by tightening the fixing screws 31 in a state of being screwed into the female thread portions 61, the flange portion 35 is abutted against the peripheral edge portion of the through hole 47 of the camera attachment surface component 23.

By further tightening the fixing screws 31 in a state where the flange portion 35 is abutted against the peripheral edge portion of the through hole 47 of the camera attachment surface component 23, the camera attachment surface component 23 is lifted in the Z direction and is sandwiched and fixed between the contact surface 49 of the nut 25 and the fixing screws 31. The camera attachment surface component 23 sandwiched between the contact surface 49 of the nut 25 and the fixing screws 31 cannot rotate in the Pan direction.

FIG. 5 is a cross-sectional view of the attachment member 27 shown in FIG. 4, which is taken along a line C-C.

In the fastening member 21, in a state where the camera attachment surface component 23 is fixed (sandwiched), an inner space of the connecting tube portion 39 opens to an inside of the attachment surface 41 of the camera attachment surface component 23. That is, the inner space of the fastening member 21 is in communication with internal spaces of each of the support portion 17, the mount bracket 19A, and the support pipe portion 19B, and functions as a duct 63 for drawing a power line, a communication cable, and the like of the surveillance camera 11 to the attachment surface 41.

A fall prevention wire 65 shown in FIG. 3 is inserted into the duct 63 of the fastening member 21. The fall prevention wire 65 is passed through an inside of the support pipe portion 19B, drawn into the duct 63, drawn out from an attachment surface side of the camera attachment surface component 23 (that is, an opening portion of the flange portion 35), and disposed on the attachment surface 41. As shown in FIG. 3, the fall prevention wire 65 disposed on the attachment surface 41 is hooked on one of thin piece portions 67 formed on the flange portion 35.

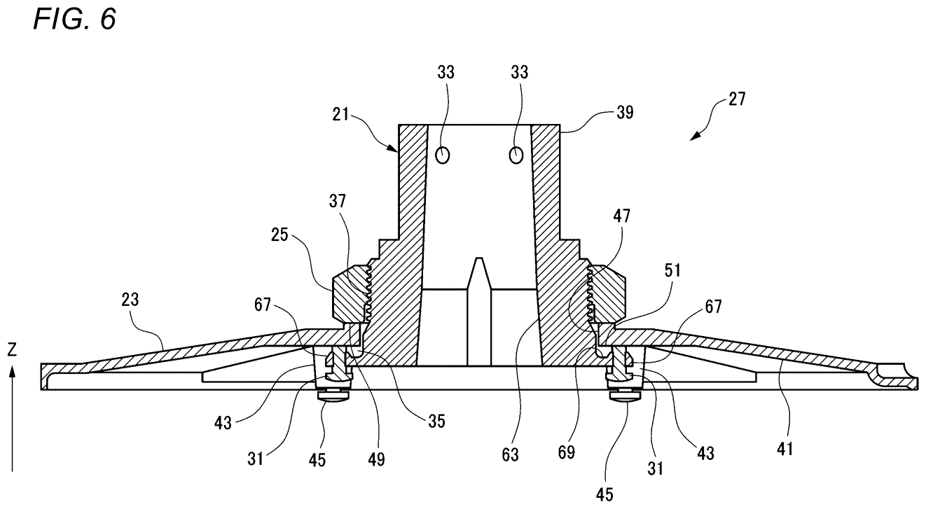

FIG. 6 is a cross-sectional view taken along a line D-D in FIG. 4.

In the flange portion 35, a plurality of (for example, two) thin piece portions 67 are formed at substantially equal intervals in a circumferential direction of the flange portion 35. The thin piece portion 67 is formed such that a part of the flange portion 35 is thin, and for example, is formed to be thin by reducing a thickness of a surface on a side facing the camera attachment surface component 23. Accordingly, a gap 69 (see FIG. 7) is formed between each of the thin piece portions 67 and the camera attachment surface component 23.

FIG. 7 is an enlarged view of a main part shown in FIG. 6.

In the fastening member 21, the fixing screws 31 that push up the camera attachment surface component 23 toward the nut 25 are respectively screwed into the female thread portions 61 of the thin piece portions 67 in each of which a part of the flange portion 35 is formed to be thin.

When pushing up the camera attachment surface component 23 by screwing, each of the fixing screws 31 receives a reaction force from the camera attachment surface component 23. At this time, since the thin piece portion 67 is formed to be thinner than the thick flange portion 35, the thin piece portion 67 is elastically deformed by the reaction force received from the camera attachment surface component 23. The thin piece portion 67 can prevent the nut 25 from loosening due to an elastic restoring force.

Further, the thin piece portion 67 is thinned by cutting the surface on a side facing the camera attachment surface component 23. Therefore, the gap 69 is formed between the thin piece portion 67 and the camera attachment surface component 23. The gap 69 can hook an annular loop portion 71 (see FIG. 3) provided at a tip end of the fall prevention wire 65, the tip end of the fixing screw 31 screwed into the thin piece portion 67 is abutted against the camera attachment surface component 23, and thus the outer peripheral open side on a radially outer side of the flange portion 35 is closed.

Accordingly, the loop portion 71 of the fall prevention wire 65 hooked on the thin piece portion 67 closes the gap 69, is not detached from the thin piece portion 67, and is firmly held by the flange portion 35. That is, the thin piece portion 67 has both a function of preventing loosing of the nut 25 and a function of fixing the fall prevention wire 65.

As described above, the camera attachment member 27 according to Embodiment 1 is capable of attaching the surveillance camera 11 (an example of a camera) to a support pipe portion 19B fixed to a support portion 17 (an example of a support) that supports the surveillance camera 11 at an attachment position, the camera attachment member 27 includes: a fastening member 21 with one end portion thereof fixed to the support pipe portion 19B, the fastening member including a flange portion 35 formed at the other end portion opposite to the one end portion, and a male thread portion 37 having a diameter smaller than that of the flange portion 35; a camera attachment surface component 23 having a through hole allowing the one end portion of the fastening member 21 to be inserted therethrough; and a nut 25 capable of being screwed with the male thread portion 37 of the fastening member 21, and the camera attachment surface component 23 placed on the flange portion 35 and rotatable along a rotation direction of the male thread portion 37 is sandwiched between the flange portion 35 and the nut 25.

Accordingly, by inserting the fastening member 21 into the through hole 47, the camera attachment member 27 according to Embodiment 1 can support the camera unit 13 in a state where a peripheral edge of the through hole 47 formed to have a diameter smaller than that of the flange portion 35 is placed on the flange portion 35 of the fastening member 21 and the attachment direction of the camera unit 13 is rotatable in the Pan rotation direction. In the camera attachment member 27, the nut 25 is screwed and tightened to the male thread portion 37 protruding from the through hole 47 of the camera attachment surface component 23 in a state where the fastening member 21 is inserted into the through hole 47, and thus the peripheral edge of the through hole 47 on the upper surface (a surface opposite to the attachment surface 41) of the camera attachment surface component 23 is tightened. Accordingly, the camera attachment surface component 23 placed on the flange portion 35 of the fastening member 21 is rotated to the attachment position desired by the user before the nut 25 is completely tightened, then the nut 25 is tightened by the worker, and thereby the camera attachment surface component 23 is sandwiched between the nut 25 and the flange portion 35, and the camera attachment surface component 23 can be locked in a manner of being non-rotatable in the Pan direction. Therefore, the camera attachment member 27 can more easily adjust the attachment direction of the camera unit 13 attached to the camera attachment surface component 23.

Further, the flange portion 35 of the camera attachment member 27 according to Embodiment 1 includes the female thread portions 61 each penetrating the flange portion 35 in the thickness direction thereof, and the camera attachment surface component 23 is pressed by the tip ends of the fixing screws 31 screwed into the female thread portions 61 from the side opposite to the camera attachment surface component 23. Accordingly, in the camera attachment member 27 according to Embodiment 1, the fixing screws 31 are screwed and tightened to the female thread portions 61 from the side opposite to the camera attachment surface component 23, and thus the camera attachment surface component 23 can be fixed in a state of being pushed up in the Z direction by the tip ends of the fixing screws 31. That is, in the camera attachment member 27, by tightening the fixing screws 31, the camera attachment surface component 23 can be set to a state of being more strongly pressed against the nut 25, and can be more firmly fixed.

Further, in the camera attachment member 27 according to Embodiment 1, the under-head length of the fixing screw 31 is longer than the thickness of the flange portion 35. Accordingly, in the camera attachment member 27 according to Embodiment 1, the fixing screws 31 tightened to the female thread portions 61 penetrate the flange portion 35, the tip ends of the penetrating fixing screws 31 are abutted against the camera attachment surface component 23, and the camera attachment surface component 23 can be pressed in a direction (Z direction) of the nut 25. An entire length of each of the fixing screws 31 may be a length that does not interfere with the camera unit 13 attached to the attachment surface 41 of the camera attachment surface component 23 in a state where the pressing of the camera attachment surface component 23 is completed.

Further, the camera attachment surface component 23 of the camera attachment member 27 according to Embodiment 1 has a mark Mk (an example of a mark) indicating the front position of the camera. Accordingly, in the camera attachment member 27 according to Embodiment 1, a fixing position of the camera attachment surface component 23, that is, the attachment direction of the camera unit 13 attached to the camera attachment surface component 23 can be adjusted while visually confirming the position via the mark Mk of the camera attachment surface component 23.

Further, each of the female thread portions 61 of the camera attachment member 27 according to Embodiment 1 is provided in the thin piece portion 67 obtained by forming a part of the flange portion 35 to be thin. Accordingly, in the camera attachment member 27 according to Embodiment 1, the thin piece portion 67 is elastically deformed by a reaction force received from the camera attachment surface component 23 due to the screwing of the fixing screw 31, and thus loosing of the nut 25 can be prevented by an elastic restoring force of the thin piece portion 67 against the reaction force.

Further, on the thin piece portion 67 of the camera attachment member 27 according to Embodiment 1, the fall prevention wire 65 inserted through insides of the fastening member 21 and the support pipe portion 19B and pulled out from the other end portion is locked. Accordingly, in the camera attachment member 27 according to Embodiment 1, even in a case where the fixing between the support pipe portion 19B and the fastening member 21 is loosened and the attachment member 27 is detached from the support pipe portion 19B, the fall prevention wire 65 whose one end is fixed to the support portion 17 is hooked on the thin piece portion 67 of the flange portion 35 of the fastening member 21, and the surveillance camera 11 (camera unit 13) can be prevented from falling down.

Although various embodiments have been described above with reference to the accompanying drawings, the present disclosure is not limited to such examples. It is apparent to a person skilled in the art that various changes, corrections, substitutions, additions, deletions, and equivalents can be conceived within the scope of the claims, and it is understood that such modifications also belong to the technical scope of the present disclosure. The components in the various embodiments described above may be freely combined without departing from the gist of the invention.

The present application is based on Japanese Patent Application (Japanese Patent Application No. 2022-169944) filed on Oct. 24, 2022, and the contents thereof are incorporated herein by reference.

### INDUSTRIAL APPLICABILITY

The present disclosure is useful as a camera attachment member allowing a camera attachment direction to be easily adjusted.

### REFERENCE SIGNS LIST

11: surveillance camera
17: support portion
19A: mount bracket
19B: support pipe portion
21: fastening member
23: camera attachment surface component
25: nut
27: attachment member
29: fixing screw
31: fixing screw
35: flange portion
37: male thread portion
41: attachment surface
47: through hole
61: female thread portion
65: fall prevention wire
67: thin piece portion
Mk: mark

1. A camera attachment member capable of attaching a camera to a support pipe portion fixed to a support member that supports the camera at an attachment position, the camera attachment member comprising:
a fastening member with one end portion thereof fixed to the support pipe portion, the fastening member including a flange portion formed at another end portion opposite to the one end portion, and a male thread portion having a diameter smaller than that of the flange portion;
a camera attachment surface component having a through hole allowing the one end portion of the fastening member to be inserted therethrough; and
a nut capable of being screwed with the male thread portion of the fastening member, wherein
the camera attachment surface component placed on the flange portion and rotatable along a rotation direction of the male thread portion is sandwiched between the flange portion and the nut.

2. The camera attachment member according to claim 1, wherein
the flange portion includes a female thread portion penetrating the flange portion in a thickness direction thereof, and
the camera attachment surface component is pressed by a tip end of a fixing screw screwed into the female thread portion from a side opposite to the camera attachment surface component.

3. The camera attachment member according to claim 2, wherein
an under-head length of the fixing screw is longer than a thickness of the flange portion.

4. The camera attachment member according to claim 1, wherein
the camera attachment surface component has a mark indicating a front position of the camera.

5. The camera attachment member according to claim 2, wherein
the female thread portion is provided in a thin piece portion obtained by forming a part of the flange portion to be thin.

6. The camera attachment member according to claim 5, wherein
a fall prevention wire inserted through insides of the fastening member and the support pipe portion and pulled out from the other end portion is locked on the thin piece portion.
